(19) United States
(12) Patent Application Publication
(10) Pub. No.: US 2010/0304764 A1
(43) Pub. Date: Dec. 2, 2010

(54) FEMTO CELL SERVICE DELIVERY PLATFORM REAL-TIME VOTING AND FEEDBACK

(75) Inventors: Jeffrey Sweeney, Olathe, KS (US); Kelsyn D.S. Rooks, Overland Park, KS (US)

Correspondence Address: SNR DENTON US LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/471,708

(22) Filed: May 26, 2009

(51) Int. Cl. H04W 4/12

(52) U.S. Cl. 455/466

(57) ABSTRACT

Embodiments of the disclosed invention include an apparatus, method, and computer program product for providing a local cellular feedback network to enable communication with a plurality of cellular devices within an enclosed area without communicating through a wireless carrier network. For instance, certain of the disclosed embodiments may be utilized, but are not limited to, enabling localize voting and auctioning via regular cellular devices. In addition, certain of the disclosed embodiments may be utilized to provide other services to a user of cellular device, such as, but not limited to, ordering food items at a venue and having the ordered food items delivered to the user based on location tracking information gathered by the feedback system.

### BACKGROUND OF THE INVENTION

Cellular devices, such as, cell phones are ubiquitous in today's society. In addition to providing mobile voice communications, current cellular devices may support many additional services, such as, SMS for text messaging, email, packet switching for Internet access, and MMS for sending and receiving photos and video.

The disclosed embodiments provide a novel way of communicating with a plurality of cellular devices. In particular, the disclosed embodiments provide an apparatus, method, and computer program product for providing a local area cellular communication network for communicating with a plurality of cellular devices within an enclosed area without routing the communication over a wireless carrier/service provider cellular network.

### SUMMARY

Embodiments of the disclosed invention include an apparatus, method, and computer program product for providing a local cellular feedback network for communicating with a plurality of cellular devices within an enclosed area without utilizing a wireless carrier network. For instance, as will be further described, certain of the disclosed embodiments may be utilized, but are not limited to, enabling localize voting and/or auctioning using regular cellular devices. In addition, certain of the disclosed embodiments may be utilized to provide other services to a user of a cellular device, such as, but not limited to, ordering food items at a venue and, in some embodiments, having the ordered food items delivered to the user based on location information gathered by the feedback system. For example, in one embodiment, a feedback system is disclosed comprising a communication component that is configured to communicate data with a plurality of cellular devices within an enclosed area via one or more femto cells without routing the data over a wireless carrier network. Additionally, in some embodiments, the feedback system may include a processing component that processes the data from the plurality of cellular devices and a data storage component that stores the processed data. Alternatively, in other embodiments, an all-in-one intelligent femto cell may be utilized for providing a local cellular feedback network.

### BRIEF DESCRIPTION OF THE DRAWINGS

Illustrative embodiments of the present invention are described in detail below with reference to the attached figures, which are incorporated by reference herein and wherein:

FIG. 1 depicts an embodiment of a network environment in which the illustrative embodiments may be implemented;

FIG. 2 depicts an embodiment of a femto cell in accordance with certain of the illustrative embodiments;

FIG. 3 depicts an embodiment of a feedback system for providing a local cellular feedback network in accordance with some of the disclosed embodiments;

FIG. 4 depicts another embodiment of a femto cell in accordance with certain of the disclosed embodiments; and

FIG. 5 depicts an embodiment of a process for providing a local cellular feedback network for communicating with a plurality of cellular devices within an enclosed area via a non-wireless carrier network in accordance with some of the disclosed embodiments.

### DETAILED DESCRIPTION OF THE DRAWINGS

Embodiments of the disclosed invention include a system, method, and computer program product for providing a local cellular feedback network for communicating with a plurality of cellular devices within an enclosed area without communicating through a wireless carrier network (e.g., AT&T, Sprint, and/or Verizon's cellular networks). As will be further described, certain of the disclosed embodiments may be utilized to provide meeting organizers and/or event management with the ability to manage critical and timely group feedback on a local area network level without the need to interact with a wireless carrier network. For example, certain of the disclosed embodiments may be utilized in group settings, such as, but not limited to, meetings and conventions to conduct surveys, market research, voting, silent bidding at an auction, food ordering, and/or other activities via an intelligent femto cell platform operating as a single unit or in a network system.

A femto cell, as referenced herein, is a miniature cellular signal transmission device that communicates directly with cellular devices and routes cellular communications associated with the cellular devices over an IP network, such as the Internet, for facilitating cellular communications. Femto cells may be utilized to provide and/or improve cellular service to cellular devices that are located in areas that do not receive adequate cellular coverage.

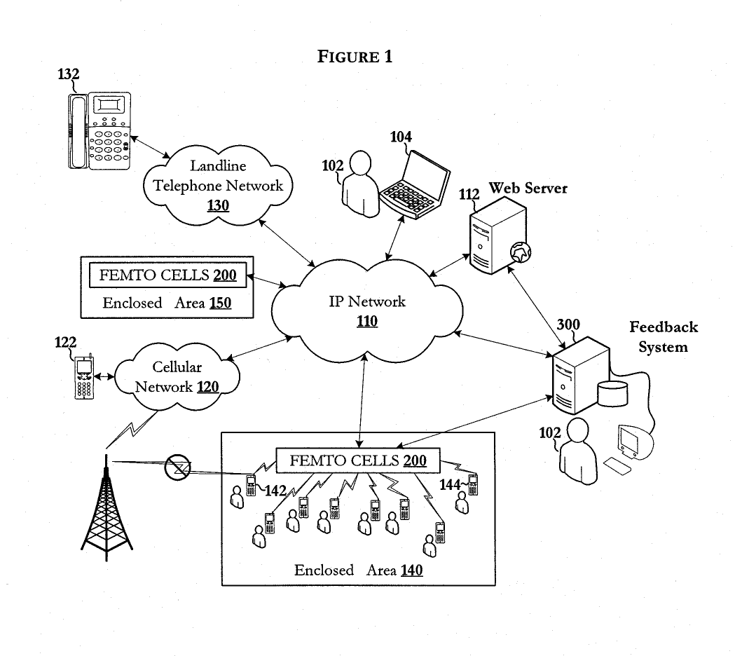

The disclosed embodiments and advantages thereof are best understood by referring to FIGS. 1-5 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and not intended to assert or imply any limitation with regard to the environment, architecture, design, or process in which different embodiments may be implemented.

FIG. 1 depicts an embodiment of a network environment 100 in which the illustrative embodiments may be implemented. In accordance with one embodiment, femto cells 200, comprising one or more femto cells, are utilized to communicate with a plurality of cellular devices located within an enclosed area, such as, enclosed area 140. Enclosed area 140 may be an enclosed area of any size including, but not limited to, a room, a building, a convention center and/or a sports complex. Additionally, in some embodiments, the portion of the enclosed area that is covered femto cells 200 by may be modified by varying the signal strengths associated with one or more of the femto cells and/or by modifying the number or location of femto cells within the enclosed area.

In one embodiment, femto cells 200 may be configured to communicate with the plurality of cellular devices on a plurality of cellular frequencies and network technology. For instance, in some embodiments, femto cells 200 may include a universal femto cell capable of communicating with cellular devices on a 850 MHz Global System for Mobile Communications (GSM) network, a 1900 MHz GSM network, a 1900 MHz Code-Division Multiple Access (CDMA) network, and a 700 MHz 3G network. Alternatively, in other embodiments, femto cells 200 may comprise of a plurality of single service provider femto cells, each capable of communicating with cellular devices on a specific cellular network frequency and/or technology. For example, in the disclosed embodiment, femto cells 200 may be configured to support cellular communications with a cellular device 142 over a first cellular frequency/network technology and support cellular communications with a cellular device 144 over a second cellular frequency/network technology.

In a preferred embodiment, femto cells 200 acts like a regular cell tower, except that femto cells 200 backhauls the voice or data communications associated with a mobile device over an IP network instead of using cellular terrestrial towers. Similar to how cellular communications is handed off from one cellular terrestrial tower to the next closest cellular terrestrial tower, in one embodiment, when a mobile communication device is within signal range of femto cells 200, the cellular communication associated with the mobile device is automatically handed off to femto cells 200. Accordingly, in a preferred embodiment, all cellular communications of mobile devices within signal range of femto cells 200 are automatically routed through femto cells 200 based on the configuration settings of femto cells 200.

For instance, in one embodiment, femto cells 200 routes all cellular communications for cellular devices located within enclosed area 140 through IP network 110 for enabling communications with other communication devices, such as, but not limited to, a cellular device 122 and a landline telephone 132. In other embodiments, femto cells 200 may route information pertaining to the cellular communication, such as, but not limited to, an identifier of the calling device and a calling number, to feedback system 300 instead of routing the entire cellular communication to feedback system 300. In other words, in some embodiments, feedback system 300 merely gathers information instead of handling the actual routing the cellular communications.

In some embodiments, IP network 110 may include one or more data networks, such as, but not limited to, the Internet, for routing communications between one or more communication devices and/or data processing systems. The Internet is a global system of interconnected computer networks that interchange data using the standardized Internet Protocol Suite (TCP/IP). Additionally, IP network 110 may include other types of data networks, such as, but not limited to, an intranet, a private local area network (LAN), a wide area network (WAN), and a wireless local area network (WLAN).

In addition, IP network 110 may communicate with other types of network, such as, but not limited to, cellular network 120 and landline telephone network 130, for routing cellular communications. In one embodiment, cellular network 120 may include one or more wireless carrier networks and one or more different types of networks, including, but not limited to, GSM networks, CDMA networks, an Enhanced Data GSM Environment (EDGE) network, and a 3G/4G network, for facilitating voice communications to cellular devices, such as, cellular device 122.

Landline telephone network 130 may include a public switched telephone network (PSTN) for facilitating voice communication to landline telephone devices, such as, landline telephone 132. The public switched telephone network is the standard analog telephone network utilized by most homes. In addition, in some embodiments, landline telephone network 130 may also include digital telephone networks, such as, but not limited to, an integrated services digital network (ISDN) and a fiber distributed data interface (FDDI) network.

In accordance with certain embodiments, femto cells 200 may communicate with a feedback system 300 over a feedback network. As referenced herein, a feedback network is defined as a network connection that communicatively couples feedback system 300 to femto cells 200 without routing the communication over a wireless carrier network, such as, cellular network 120. For example, in one embodiment, feedback system 300 may communicate with femto cells 200 via a wired or wireless direct communication link. Alternatively, in other embodiments, feedback system 300 may communicate with femto cells 200 over IP network 110. For instance, in one embodiment, feedback system 300 may be utilized to receive silent bid auctions from one or more cellular devices within enclosed area 140 and present the bid amounts to an auctioneer. For example, in one embodiment, feedback system 300 may be configured to recognize a bid from a user if the user enters a bid amount followed by a # sign and pushes the call button of a cellular device to transmit the bid. Additionally, in some embodiments, feedback system 300 may communicate with a calling names database to identify a subscriber/bidder associated with a caller ID of the transmitting device. In other embodiments, feedback system 300 may store subscriber identifying information associated with the plurality of cellular devices located within enclosed area and utilize the subscriber identifying information to identify a bidder associated with a cellular device. For example, in one embodiment, all participants of an auction, during a registration process, provide a mobile identification number of a cellular device that they will be using for bidding in the auction. In some embodiments, the registration process may be performed online. For instance, in one embodiment, participants and/or an administrator 102 may utilize an Internet accessible device, such as, but not limited to, a laptop computer 104, to access a website hosted by a Web server 112 to preregister one or more cellular devices along with subscriber identifying information. In these embodiments, Web server 112 may pass the registered information to feedback system 300. Alternatively, or in addition to, in some embodiments, feedback system 300 may locally receive registration information (e.g., an administrator may manually enter the registration information).

Similarly, in some embodiments, feedback system 300 may be utilized for real-time voting. For instance, participants at a meeting may secretly vote yay or nay for an announced proposal by transmitting *1 or *2 to feedback system 300. In one embodiment, feedback system 300 may include logic for authenticating the cellular device to ensure that ensure that only authorized users are voting and that each authorized user is only voting once. As referenced herein, logic is defined as hardware, software, and/or a combination thereof. In addition, in some embodiments, feedback system 300 may include logic for tallying up the votes. Further, in some embodiments, feedback system 300 may include logic for presenting the user inputs (e.g., votes) into a visual representation format, such as, but not limited to, a graph, a chart, and/or a table.

In certain embodiments, feedback system 300 may include logic for recognizing an improper submission. For example, in one embodiment, if feedback system 300 receives a *4 command from a cellular device, instead of a *1 or *2 command, feedback system 300 may return an error message to the transmitting cellular device. In addition, in some embodiments, feedback system 300 may transmit a confirmation message to a transmitting cellular device to indicate that a proper submission has been received.

Additionally, in some embodiments, feedback system 300 may be utilized to transmit a document including, but not limited to, surveys, questionnaires, and marketing materials to all participants at a meeting, convention, or other venue. For example, in one embodiment, a survey/questionnaire may be transmitted to all and/or a selected group of participants at a meeting as a text message. In some embodiments, the text message may include instructions for responding to the survey/questionnaire.

Similarly, in some embodiments, feedback system 300 may be utilized to order food. For example, in one embodiment, feedback system 300 may transmit a menu to each of the plurality of cellular devices in enclosed area 140. A user may transmit a menu selection choice back to feedback system 300. Alternatively, in some embodiments, feedback system 300 may include an interactive voice response (IVR) system for presenting and receiving user input via voice and/or keypad inputs. For example, in one embodiment, a user may simply press the talk button on a cellular device while located within enclosed area 140 to be connected to an interactive voice response (IVR) system of feedback system 300.

In addition, in one embodiment, feedback system 300 may identify a subscriber associated with the transmitting cellular device and determine the location of the subscriber within the enclosed area. For example, in one embodiment, feedback system 300 may triangulate the cellular signal associated with the transmitting cellular device using one or more of the femto cells 200 to determine the user's location. In other embodiments, feedback system 300 may identify a subscriber location associated with a transmitting cellular device by matching the subscriber information to location information, such as, but not limited to, a seating chart and/or ticket information associated with an event (e.g., the identified subscriber may have purchased tickets for seats number 1-2 in row 4, section AA, for a particular event occurring within enclosed area 140). Thus, in certain embodiments, a person located within an enclosed area using his own cellular device may easily order an item and have that item delivered directly to him.

In other embodiments, feedback system 300 may be utilized to provide an estimated head count of the number of people within an enclosed area based on the number of cellular devices detected by feedback system 300. Still, in some embodiments, feedback system 300 may be utilized to identify the people that attended an event, e.g., generating a participation list of the people that attended a meeting.

Further, in some embodiments, feedback system 300 may be utilized to provide cellular feedback to cellular devices located within multiple enclosed areas, such as, but not limited to, enclosed area 140 and enclosed area 150. For instance, in one embodiment, feedback system 300 may be respectfully configured with the network address identifiers of the femto cells located within enclosed area 140 and the network address identifiers of the femto cells located within enclosed area 150 for distinguishing the data between the multiple enclosed areas.

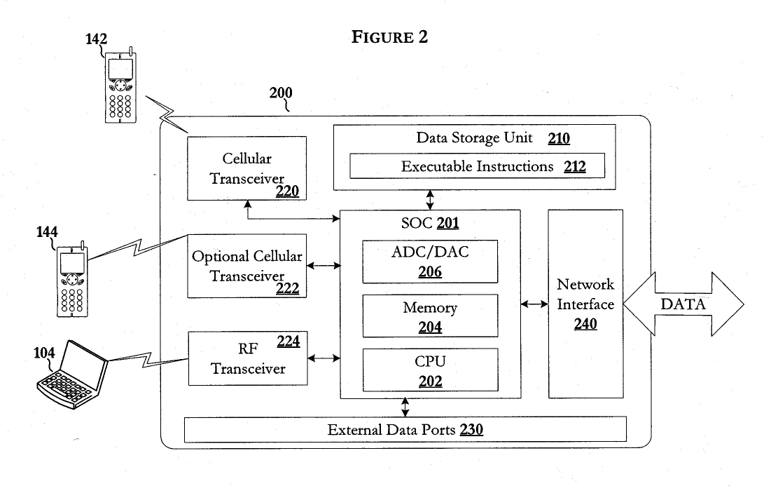

With reference now to FIG. 2, an embodiment of a femto cell 200 is presented in accordance with certain of the disclosed embodiments. In the depicted embodiment, femto cell 200 includes a system-on-a-chip (SoC) 201. In one embodiment, SoC 201 may integrate all or a majority of the components of femto cell 200 including, but not limited to, one or more processors/microprocessors 202 and memory 204 (e.g., RAM), into a single integrated circuit chip. In addition, in some embodiments, SoC 201 may include an analog-to-digital converter (ADC) and a digital-to-analog converter (DAC) 206 for converting between analog signals and digital format.

In certain embodiments, femto cell 200 may include one or more data storage unit 210, such as, but not limited to, a hard disk drive for storing executable instructions 212 and/or other data, such as, but not limited to, access rules, routing tables, and quality of service (QoS) rules for intelligent routing. For instance, in some embodiments, executable instructions 212 may include executable instructions for authenticating user access and for routing cellular communications within enclosed area 140 to feedback system 300 via network interface 240. Network interface 240 may be a network interface card, such as, but not limited to, a modem, an Ethernet card, and/or a wireless network interface card for connecting femto cell 200 to IP network 110 and/or directly to feedback system 300.

In accordance with one embodiment, femto cell 200 may include a cellular transceiver 220 for communicating cellular signals between femto cell 200 and one or more cellular devices located within an enclosed area, such as, cellular device 142. For instance, femto cell 200 may be configured to communicate with cellular device 142 on a control channel to determine the mobile identification number (MIN) or international mobile equipment identity (IMEI) associated with cellular device 142. A control channel is a logic channel carrying network information rather than the actual voice or data messages transmitted over the network for enabling cellular devices to identify themselves and their location to the cellular networks. In accordance with one embodiment, femto cell 200 may pass the MIN or IMEI associated with cellular device 142 to feedback system 300 to determine whether cellular device 142 is a registered cellular device within enclosed area 140. In some embodiments, femto cell 200 may include multiple cellular transceivers, such as, optional cellular transceiver 222. For instance, in some embodiments, optional cellular transceiver 222 may be configured to operate on a different service provider cellular network than that associated with cellular transceiver 220.

In addition, in some embodiments, femto cell 200 may include a radio frequency (RF) transceiver 224. In one embodiment, radio frequency transceiver 224 supports the Wireless Application Protocol (WAP) and/or Wi-Fi standard for enabling wireless data communication with one or more wireless Internet accessible devices, such as, but not limited to, a laptop computer and/or a PDA/phone with Wi-Fi capabilities. For instance, in one embodiment, user 102 may utilize laptop computer 104 to configure feedback system 300 and/or to configure femto cell 200. Additionally, in some embodiments, femto cell 200 may include one or more external data ports 220 (e.g., a USB port) for transferring and/or storing data on an external data storage unit and/or for connecting femto cell 200 to an external device.

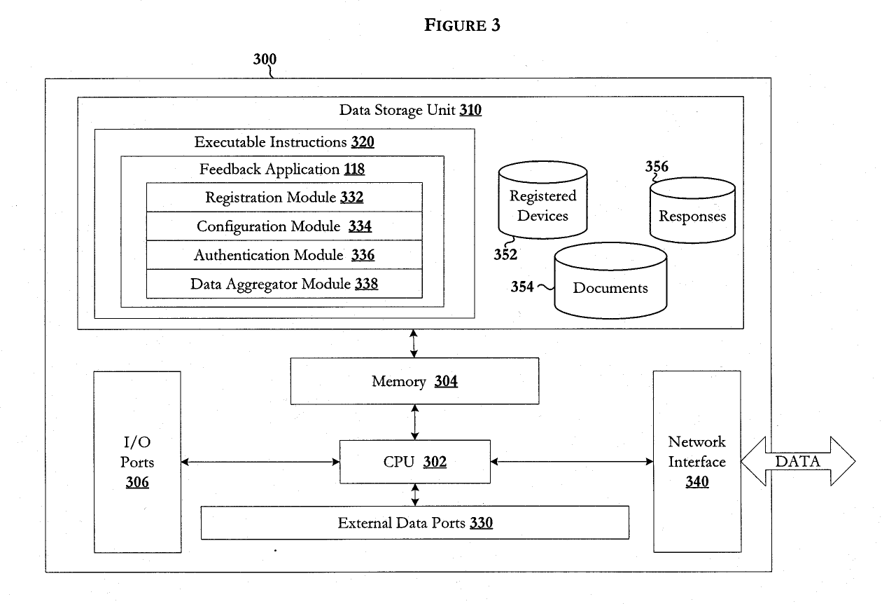

FIG. 3 depicts an embodiment of feedback system 300 for providing a local area cellular communication network in accordance with some of the disclosed embodiments. In the depicted embodiment, feedback system 300 includes, among other components, a processing unit 302, memory 304, and a data storage unit 310. Processing unit 302 serves to execute computer executable instructions stored in memory 304 and/or data storage unit 310. In one embodiment, processing unit 302 may include one or more processing cores, such as, but not limited to, a microcontroller, microprocessor, or digital signal processor, for executing instructions and processing data for providing local feedback to cellular communication devices within an enclosed area.

In certain embodiments, memory 304 may be volatile memory. Volatile memory is memory that requires power to maintain stored information. For example, in some embodiments, memory 304 may be random access memory (RAM). Random access memory stores currently executing instructions and/or other data utilized by an operating system, software application and/or hardware device.

Additionally, data storage unit 310 may be non-volatile memory, such as, but not limited to, a hard disk drive, for storing data. For example, in some embodiments, data storage unit 310 may store computer executable instructions 320 and/or other data. In some embodiments, computer executable instructions 320 may include executable instructions associated with a feedback application 118 for providing local feedback to cellular communication devices in an enclosed area. In addition, in some embodiments, data storage unit 310 may include one or more databases, such as, but not limited to, a registered devices database 352, a documents database 354, and a responses database 356. Alternatively, in some embodiments, the depicted databases may be stored on one or more remote systems and/or the data contained in the databases may be stored in other types of data structures, such as, but not limited to, a data table, a linked list, and/or an array.

In some embodiments, feedback system 300 may also include one or more external data ports 330. For example, in one embodiment, external data ports 330 may include a universal serial bus (USB) port for connecting one or more USB devices to feedback system 300, such as, but not limited to, a USB flash drive for providing external data storage. In addition, in some embodiments, feedback system 300 may include one or more input/output (I/O) ports 306 for coupling one or more input/output device to feedback system 300, such as, but not limited to, a monitor, a keyboard, and a mouse.

Further, in some embodiments, feedback system 300 may include a network interface 340. For example, in one embodiment, network interface 340 may be a network interface card, such as, but not limited to, an Ethernet card for connecting feedback system 300 to a network, such as, but not limited to, IP network 110, and/or for connecting feedback system 300 directly to femto cells 200.

In accordance with one embodiment, feedback application 118 may include a registration module 332, a configuration module 334, an authentication module 336, and a data aggregator module 330. For example, in one embodiment, registration module 332 may comprise computer executable instructions for registering one or more cellular devices that will be utilized in an enclosed area, such as, enclosed area 140. For instance, in one embodiment, a user may register his/her cellular device's phone number in conjunction with registering for an event being held at the enclosed area (e.g., an auction). In one embodiment, registration module 332 stores the registered phone number along with identifying information associated with the user, such as, but not limited to, the name and address of the subscriber, in registered devices database 352.

In certain embodiments, configuration module 334 may comprise of computer executable instructions for configuring feedback system 300. For instance, in one embodiment, configuration module 334 may include instructions for interfacing with web server 112 for receiving user specified configuration parameters. For example, in one embodiment, a user may configure feedback system 300 to recognize/identify particular star codes (e.g., *1, *2, *44, etc.) or other key sequences (e.g., 320#) that are transmitted from cellular devices within an enclosed area, hereinafter referred to as prespecified codes. Additionally, in one embodiment, a user may utilize configuration module 334 to associate the received key sequences with a particular action and/or item. For example, *1 may be associated with a yes vote, *2 with a no vote, *44 with a menu item, and 320# as a bid amount of 320 dollars.

In addition, in some embodiments, configuration module 334 may include computer executable instructions for configuring an interactive voice response (IVR) system. For instance, in one embodiment, an administrator may configure the particular options that are presented by the IVR system. Further, in some embodiments, configuration module 334 may be utilize to generate, receive, and/or retrieve documents (e.g., surveys, questionnaires, ballots, advertising material, menu, etc.) that may be transmitted to one or more of the cellular devices located within a particular enclosed area. For instance, in one embodiment, configuration module 334 may include an application programming interface (API) for enabling a user to add, delete, or modify documents in documents database 354 via a website/portal hosted on Web server 112. An application programming interface is a set of routines, data structures, object classes and/or protocols that enables other objects/applications and/or devices to call functions associated with feedback system 300.

In certain embodiments, authentication module 336 may comprise computer executable instructions for authenticating/identifying a cellular device within an enclosed area. For instance, in one embodiment, authentication module 336 may utilize the mobile identification number (MIN) or international mobile equipment identity (IMEI) associated a cellular device to determine whether the cellular device is a registered cellular device. In one embodiment, authentication module 336 may query registered devices database 352 to determine whether a detected mobile identification number is registered with feedback system 300 for a given event/location. For example, in some embodiments, authentication module 336 may enable only registered cellular devices to vote and ensures that each registered cellular device only votes once. Similarly, authentication module 336 may be utilized to ensure that only registered/verified bidders are able to place bids during an auction.

Additionally, in some embodiments, data aggregator module 338 may comprise of computer executable instructions for receiving responses/data transmissions from a plurality of cellular devices within an enclosed area. For example, in some embodiments, data aggregator module 338 may tally the responses to a ballot, survey, and/or questionnaire and present the data in a presentation format, such as, but not limited to, a graph, chart, or table. In addition, in some embodiments, data aggregator module 338 may be configured to transmit the results back to one or more of the plurality of cellular devices within the enclosed area and/or to another remote device. Additionally, in some embodiments, data aggregator module 338 may store the responses associated with a document in responses database 356.

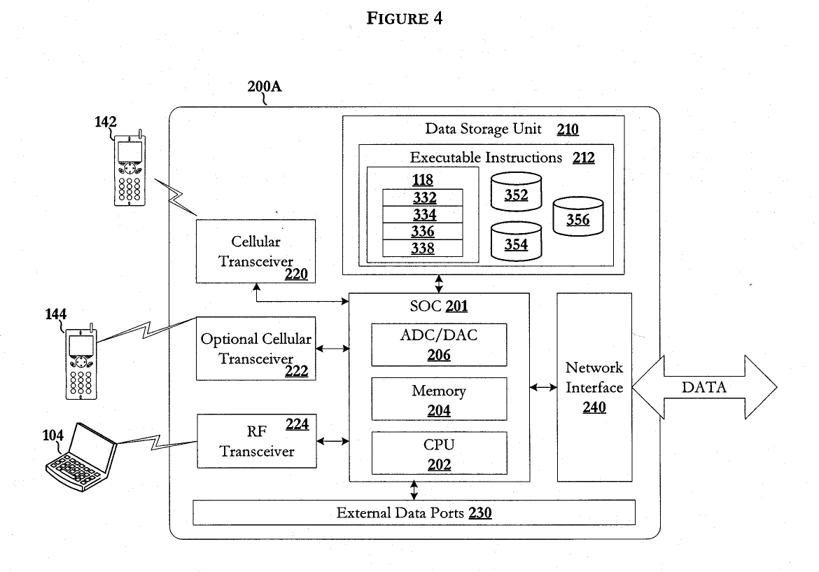

With reference now to FIG. 4, an embodiment of a femto cell 200A is depicted in accordance with certain of the disclosed embodiments. For example, in one embodiment, femto cell 200A may include all of the components as presented in femto cell 200 as shown in FIG. 2. In addition, in certain embodiments, femto cell 200A may incorporate the logic of feedback system 300, as described above, into an all-in-one intelligent femto cell. In these embodiments, femto cell 200A may communicate with a Web server, such as, Web server 112 for receiving configuration and document data. Alternatively, in some embodiments, femto cell 200A may include logic for enabling a user to configure femto cell 200A locally. For example, in one embodiment, a user, using laptop computer 104, may communicate wirelessly with femto cell 200A, via radio frequency (RF) transceiver 224, to configure femto cell 200A. In other embodiments, a data processing system may communicate with femto cell 200A using a wired connection via network interface 240. Accordingly, in some embodiments, femto cell 200A may be a stand-alone system capable of performing some or all of features associated with the disclosed embodiments.

FIGS. 2-4 are not intended to imply and/or restrict the architecture, functionality, and operation of other possible implementations of femto cell 200, femto cell 200A, and feedback system 300 that are within the scope of the disclosed embodiments. For example, other possible implementations may include additional components not depicted in FIGS. 2-4 and/or the deletion/combination of one or more of the illustrated components. In addition, although, the depicted embodiment in FIG. 3 describes the modules as computer implemented instructions, the features and functions provided by the modules may be in any form of logic including an entirely hardware embodiment or an embodiment containing both hardware and software elements. In addition, in some embodiments, the disclosed modules may be implemented in software, including, but not limited to, firmware, resident software, and microcode, that are executed by a processor, such as, but not limited to, processing unit 302.

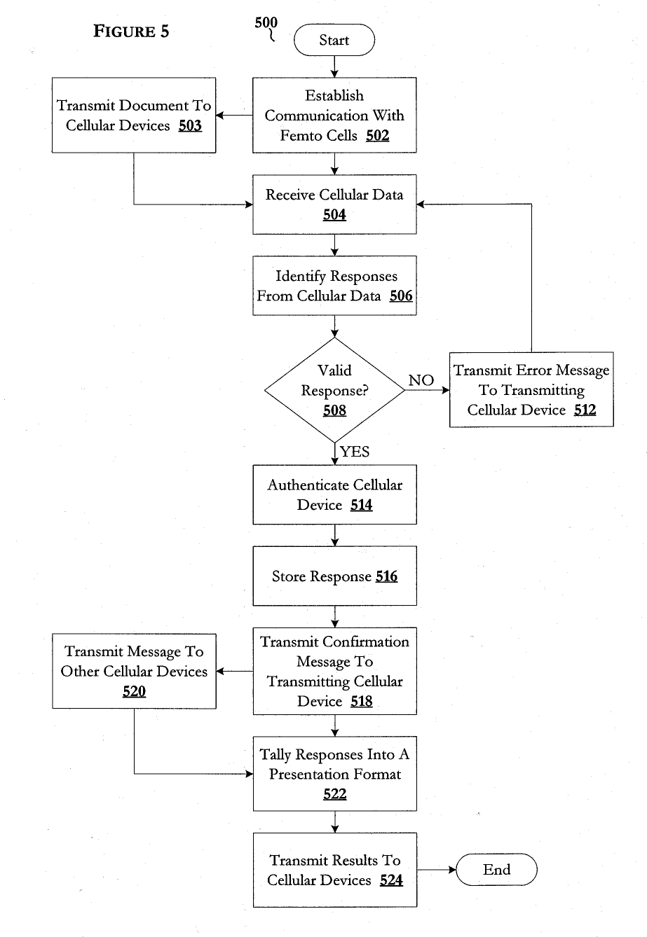

With reference now to FIG. 5, an embodiment of a process 500 for providing a local area cellular feedback network in accordance with some of the disclosed embodiments is presented. Process 500 may be executed by a data processing system such as feedback system 300 that is in communication with a plurality of femto cells that are placed within an enclosed area. Process 500 begins, at step 502, by establishing communication with one or more femto cells located within an enclosed area for providing cellular communications to one or more cellular devices located within the enclosed area. In one embodiment, process 500, at step 504, receives data from one or more of the cellular devices via the femto cells without routing the data over a wireless carrier network. At step 506, the process determines whether the data is associated with a prespecified response, such as, but not limited to, a particular sequence of key codes (e.g., *1, 111, or 111# followed by a talk/send command). Alternatively, in some embodiments, process 500, at step 503, may transmit a document (e.g., a ballot, survey, or menu) to one or more of the cellular communication devices in which the prespecified responses may be associated with.

In some embodiments, process 500, at step 508, determines whether the received response is a valid response. In one embodiment, if process 500 determines that a received response is not a valid response, the process, at step 512, transmits an error message to the transmitting cellular device via the femto cells. In some embodiments, process 500 may, at step 514, identify/authenticate the identity of the transmitting cellular device and confirm that the identified transmitting cellular device is an authorized/registered cellular device. For instance, in some embodiments, only authorized/registered cellular devices may partake in an auction. In other embodiments, authentication may be utilized to ensure that a particular cellular device is only allowed one response (e.g., each registered cellular device/user may only vote once for a particular proposition). In addition, in some embodiments, the process, at step 516, may store the received responses in a data storage component for later retrieval and further processing.

Additionally, in some embodiments, process 500 may, at step 518, transmit a confirmation message to a transmitting cellular device in response to receiving a valid response from the transmitting cellular device. For instance, in some embodiments, the confirmation message may include the transmitted response (e.g., “received yes vote to preposition 1” or “received bid for $1000 on auction item 12” or “received order for hamburger and fries”). Further, depending on the particular circumstance, process 500, at step 520, may transmit a message via the femto cells to one or more of the other cellular devices located within the enclosed area (e.g., to notify other bidders that the bid amount has been raised to X dollars).

Additionally, in some embodiments, process 500 may, at step 522, accumulate/tally the received responses (e.g., votes) into a presentable format, such as, but not limited to, a chart, table, and/or graph. In addition, as in some embodiments, process 500 may, at step 524, transmit the results to one or more of the cellular devices located within the enclosed area, with process 500 terminating thereafter. For example, in some embodiments, a table depicting the results may be transmitted to one or more of the cellular devices in the form of a text message.

Accordingly, certain of the disclosed embodiments provide a local cellular feedback network for communicating with a plurality of cellular devices within an enclosed area over a feedback network. For instance, certain of the disclosed embodiments may be utilized, but are not limited to, enabling localize voting and auctioning via regular cellular devices. In addition, certain of the disclosed embodiments may be utilized to provide other services to a cellular device user, such as, but not limited to, ordering food items at a venue and having the ordered food items delivered to the user based on location tracking information gathered by the feedback system.

The disclosed embodiments are described above with reference to flowchart illustrations, sequence diagrams, and/or block diagrams. Each block of the flowchart illustrations and/or block diagrams, and combinations of blocks in the flowchart illustrations and/or block diagrams, may be implemented by computer program instructions. In addition, the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which may include one or more executable instructions for implementing the specified logical function(s).

In some alternative implementations, the functions noted in the block may occur out of the order noted in the figures, such as, those depicted in FIG. 5. For instance, in some embodiments, process 500 may combine and/or omit certain of the presented as steps. In addition, two blocks shown in succession may, in fact, be executed substantially concurrently, or the blocks may sometimes be executed in the reverse order, depending upon the functionality involved. Further, in some embodiments, each block of the block diagrams and/or flowchart illustration, and combinations of blocks in the block diagrams and/or flowchart illustration, may be implemented entirely with hardware or as a software embodiment (including firmware, resident software, microcode, etc.) or an embodiment combining software and hardware aspects for performing the specified functions or acts.

Additionally, computer program instructions for executing the disclosed embodiments may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a data processing apparatus to cause a series of operational steps to be performed on the data processing system to produce a computer implemented process such that the instructions which execute on the data processing system provide processes for implementing the functions/acts specified in the flowchart and/or block diagram block or blocks.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The disclosed embodiments were chosen to explain the principles of the invention and the practical application, and to enable others of ordinary skill in the art to understand the invention for various embodiments with various modifications as are suited to the particular use contemplated.

We claim:

1. A feedback system comprising:
a communication component that is configured to communicate data with a plurality of cellular devices via one or more femto cells over a feedback network;
a processing component that processes the data from the plurality of cellular devices to identify a prespecified code; and
logic for identifying a particular cellular device that transmitted the identified prespecified code and associating the identified prespecified code with the particular cellular device.

2. The feedback system of claim 1, further comprising logic for transmitting a selected document to one or more of the cellular devices and receiving responses associated with the document from the one or more of the cellular devices.

3. The feedback system of claim 2, wherein the plurality of cellular devices are located within an enclosed area.

4. The feedback system of claim 2, wherein the communication component is further configured to communicate with a web server for receiving the selected document.

5. The feedback system of claim 2, wherein the selected document is a survey and the responses are answers to the survey.

6. The feedback system of claim 2, wherein the selected document is a ballot and the responses are selections associated with the ballot.

7. (canceled)

8. The feedback system of claim 2, further comprising logic for determining whether the responses are valid responses and for retransmitting the selected document to a cellular device associated with the responses in response to a determination that the responses are invalid responses, wherein the retransmit document includes an indication that a prior response was invalid.

9. The feedback system of claim 1, wherein the cellular devices are unmodified cell phones belonging to subscribers of the cellular devices.

10. The feedback system of claim 1, further comprising logic for communicating with a web server for registering subscriber information associated with plurality of cellular devices located in an enclosed area.

11. The feedback system of claim 1, further comprising:
the data storage component storing identification data associated with cellular devices within the enclosed area; and
the processing component executing instructions to identify a particular cellular device associated with the data using the stored identification data.

12. The feedback system of claim 10, wherein the data represents a bid on an auction item.

13. The feedback system of claim 10, further comprising the processing component executing instructions to generate a list of participants using the stored identification data.

14. The feedback system of claim 1, further comprising logic for transmitting a confirmation message to a particular cellular device in response to receiving data from the particular cellular device.

15. The feedback system of claim 1, further comprising an interactive voice response component for communicating information and receiving responses from one or more cellular devices located in the enclosed area.

16. The feedback system of claim 1, further comprising logic for compiling the data received from the plurality of cellular devices into a visual representation format.

17. The feedback system of claim 15, wherein the visual representation format includes one of a graph, a chart, or a table.

18. The feedback system of claim 1, further comprising logic for determining a location of a transmitting cellular device within an enclosed area using one or more of the femto cells for triangulating the cellular signal associated with the transmitting cellular device.

19. The feedback system of claim 1, further comprising logic for determining a location of a transmitting cellular device within an enclosed area using ticketing information associated with an event being held at the enclosed area.

20. A computer implemented method for communicating with a plurality of cellular devices, the computer implemented method comprising:
receiving data from a plurality of cellular devices via one or more femto cells over a feedback network;
processing the data from the plurality of cellular devices; and
providing feedback to the plurality of cellular devices via the feedback network.

21. A femto cell comprising:
a communication component that is configured to communicate a document to a plurality of cellular devices and receive responses associated with the document from the plurality of cellular devices;
a data storage component that stores identification data associated with the plurality of cellular devices; and
a processing component executing instructions to correlate responses to a respective cellular device using the stored identification data.
